(19) United States
(12) Patent Application Publication
(10) Pub. No.: US 2018/0079669 A1
(43) Pub. Date: Mar. 22, 2018

(54) METHOD FOR SELECTION OF APPROPRIATE LOCATION TO REDUCE THE ATMOSPHERIC CARBON DIOXIDE THROUGH LARGE-SCALE IRON FERTILIZATION WITH LESS ACCUMULATION RATE OF VOLCANIC SULFUR COMPOUNDS

(71) Applicant: G-LAND, Hwaseong-si (KR)

(72) Inventor: Tai-Jin KIM, Hwaseong-si (KR)

(21) Appl. No.: 15/825,378

(22) Filed: Nov. 29, 2017

Related U.S. Application Data
(63) Continuation-in-part of application No. PCT/KR2015/007698, filed on Jul. 23, 2015.

(51) Int. Cl. C02F 3/32; B01D 53/62

(52) U.S. Cl. CPC C02F 3/322; A01G 33/00; B01D 53/62

(57) ABSTRACT

The objective of the present invention is to show that HNLC (high-nutrient-low-chlorophyll) regions may be formed by locking iron as sedimentary FeS/FeS₂ at their hypoxic deep oceans in terms of sulfur compounds available from volcanic eruptions to be isolated from surrounding Oceans by Currents and Winds. Other 3 possible regions of LNHC (low-nutrient-high-chlorophyll), HNHC (high-nutrient-high-chlorophyll) and LNLC (low-nutrient-low-chlorophyll) are also explained by the relative degree of the accumulation rates of iron and sulfur, which implies the importance of desolate areas of deserts and volcanoes for the living organisms on Earth. Appropriate locations and schemes for large-scale sequestration of atmospheric CO₂ are suggested to be far from volcanoes, earthquakes and boundaries of tectonic plates for less availability of sulfur compounds.

### CROSS-REFERENCE TO RELATED APPLICATIONS

The present application is a continuation-in-part of International Patent Application No. PCT/KR2015/007698, filed on Jul. 23, 2015.

### TECHNICAL FIELD

The present method is related to the appropriate location for the large-scale sequestration of the atmospheric carbon dioxide. It is well-known that such a carbon dioxide is the main reason of the recent climate change. Many investigators have attempted internationally to resolve the problem of temperature increase caused by the enormous fuel combustion. Ever since John Martin proposed the iron hypothesis in 1988 to reduce the atmospheric CO₂, 14 mesoscale iron fertilization experiments have been carried out in HNLC regions until 2012. However, none has yet demonstrated economically feasible results so far. As pointed out by Boyd in 2005, the right choice for the location of future experiment is so important to be successful in the atmospheric CO₂ sequestration. The present method shows the details in regard to the selection of appropriate location to reduce the atmospheric CO₂ through the large-scale iron fertilization.

### BACKGROUND

The recent necessity of sequestering atmospheric CO₂ produced enormously by fossil fuel combustion to be within the emission standards set up by the 2005 Kyoto Protocol to the United Nations Framework Convention on Climate Change, ever since several countries and the European Union have established carbon offset markets which trade certified emission reduction credits (CERs) and other types of carbon credit instrument internationally.

The hypothesis of iron fertilization was speculated by English biologist Joseph Hart in 1934, raised by John Gribbin in 1988, and renewed by American oceanographer John Martin four months later. As reviewed by Dugdale and Wilkerson, Barber and Ryther described an area of east of the Galapagos Islands in 1969 and Strickland et al. had interests in waters exhibiting relatively abundant nutrients, but low chlorophyll and low productivity in 1969. Minas et al. has firstly designated the terms of “high nutrient, low chlorophyll (HNLC)” in 1986. Martin's iron enrichment experiments into the amounts of carbon drawn into the seas by algae formed the basis for 14 mesoscale international efforts during the last 20 years to understand the ocean's role in the Earth's carbon budget. However, none has yet demonstrated economically feasible results so far. Therefore, further modification of such experimental protocols should be scientifically developed so that Martin's hypothesis come true in large scale. 14 mesoscale iron enrichment experiments have been carried out at southern Africa, Australia, and New Zealand of the Southern Ocean with the Equatorial Pacific and the Subarctic Pacific. As pointed out by Boyd in 2005, the right choice for the location of future experiment is so important to be successful in the atmospheric CO₂ sequestration.

In most regions of the world ocean photosynthetic production is limited by the availability of the nutrients nitrate and phosphates. Regions where nutrients concentrations are high, are usually characterized by high concentrations of chlorophyll in surface waters. There are, however, large areas of the world ocean (>30%) where the concentrations of nutrients are high yet chlorophyll is low (that is, high-nutrient-low-chlorophyll (HNLC) waters). Martin and Fitzwater hypothesized in 1988 that primary productibity in HNLC regions was limited by the availability of iron while HNLC regions consist of the Subarctic Pacific, Equatorial Pacific, and Southern Ocean, as illustrated in Table 1. Deposition of iron to these regions also has imporant implications for the CO₂ sequestration, as increases in iron to the oceans may result in increased photoplankton growth and hence a decrease of CO₂ in the atmosphere (Mahowald et al., 2005).

TABLE 1
Distribution of nutrients, chlorophyll
and aeolian dust in HNLC regions.

| | | | | | Aeolian dust |
|---|---|---|---|---|---|
| | | Phos- | | Chloro- | (Tan et al., |
| | Nitrate | phate | Silicate | phyll- | 2013) |
| HNLC | (μM) | (μM) | (μM) | a (μg l)⁻¹ | (g m⁻² yr⁻¹) |
| Southern Ocean | 31 | 3.4 | 32 | 2.2 | 4 |
| (Scotia Sea) | | | | | |
| (Dugdale and | | | | | |
| Wilkerson, 1991) | | | | | |
| Equatorial Pacific | 7 | 1.0 | 3 | 0.3 | 7 |
| (Dugdale and | | | | | |
| Wilkerson, 1991) | | | | | |
| Subarctic Pacific | 10.97 | 1.17 | 23.18 | 0.72 | 14 |
| (Tan et al., 2013) | | | | | |

Iron is an important limiting nutrient for algae, which use it to produce chlorophyll and protein. Photosynthesis depends on adequate iron supply, whose concentration in water is quite low because of its low solubility. The primary producers in the ocean that absorb iron are typically phytoplankton or cyanobacteria. Iron is then assimilated by consumers when they eat the bacteria or plankton, the latter providing a crucial source of food to many large aquatic organisms such as fish and whales. When animals, fishes and plankton die, decomposing bacteria return iron to the soil and the water.

Hematite (Fe₂O₃) and goethite (FeOOH) in the aeolian dust tend to be associated with fine (0.3˜1 μm) particles, with long residence times (days) in the atmosphere and thus potentially long transport paths (Maher et al., 2010).

Under oxic conditions typifying surface waters, Fe exists largely in the oxidized ferric (Fe³⁺) form; as insoluble oxides, hydroxides, and carbonates which readily precipitate and deposit in the sediments. Under anoxic conditions, Fe may be released from the sediments as more available reduced Fe²⁺ prior to algal blooms, as shown stepwisely in FIG. 1.

Since the solubility of N₂ is very low in comparison with those of CO₂ (high), PO₄³⁻ (moderate), and SO₂ (very high), the overall algal growth rate is governed by the rate of N assimilation and N₂ fixation, requiring a plenty of iron atoms. The Subarctic and Equatorial Pacific and the Southern Ocean surrounding the Antarctic, are collectively known as “high nutrient-low chlorophyll” (HNLC) regions. This is because HNLC algal populations are surprisingly low, considering the relatively high availability of most mineral nutrients there. In HNLC regions extremely low levels of dissolved iron (0.000004 ppm) (Boyd et al., 2001) explain the low algal productivity. However, Synechococcus reached high densities in most HNLC regions. This may be caused by its ability to synthesize siderophores, iron-binding compounds, which facilitated the transport of iron ion into cells within 2 hours (Walsh and Steidinger, 2001) during periods of iron deficiency. Iron is an enzyme cofactor in numerous biochemical pathways. Specifically, enzymes involved in photosynthesis, electron transport, energy transfer, N (specifically nitrate and nitrite) assimilation, and (in the case of cyanobacteria) N₂ fixation require iron. In nitrogen-fixing cells, each nitrogenase complex contains 32 to 36 iron atoms (Graham et al., 2009). Photosynthetic cells require relatively large amounts of iron for photosystem reaction centers. Photosynthesis takes place in chloroplast to capture light energy, whose principal photoreceptor is chlorophyll-a with molecular formula of C₅₅H₆₈O₅N₄Mg. The number of nitrogen atom is thus four per molecule of chlorophyll-a, which requires four NH₄⁺ ions to be synthesized to chlorophyll by nitrogenase complex. Since 14 iron atoms are necessary during the process of photosystem I and 32 to 36 iron atoms are contained in nitrogenase complex during N₂ fixation, and thus, (14×4)+(32˜36)=88˜92 iron atoms can be minimally necessary for the biosynthesis of a molecule of chlorophyll-a. Each photosynthetic cell contains 40˜200 chloroplasts while each chloroplast has grana containing 10˜20 thylakoid and thylakoid membrane is covered with 300 chlorophylls (Lewis et al., 2009). It is thus expected that each photosynthetic cell contains 1.2×10⁵˜1.2×10⁶ chlorophylls to be approximated that each photosynthetic cell of algae requires iron atoms as much as: (88˜92 iron atoms/chlorophyll-a)×(1.2×10⁵˜1.2×10⁶ chlorophyll-a/algae cell)=1×10⁷˜1×10⁸ iron atoms/algae cell, which can be close to the experimental observation of intracellular iron quota (Henley and Yin, 1998) for Synechococcus spp. of ˜10⁻¹⁸ mol/cell (˜1×10⁶ iron atoms/cell). Since the algal concentration is in the range of 10⁶ cells/ml during algal blooms (Ahn et al., 2004), the resultant iron atom concentration can be 1×10¹³˜1×10¹⁴ iron atoms/ml. If blooming patch is assumed to have 100 meter long, 100 meter wide and 1 meter deep during photosynthesis, its volume can be 10⁴ m³ or 10⁷ liter. Thus, the required iron atoms in such a volume can be 1×10²³˜1×10²⁴ iron atoms during algal blooms. Besides, one mole of iron is 55.8 g with 6×10²³ atoms, the corresponding iron concentration is 0.001˜0.01 ppm

$$\{ = \frac{( 1 \times {10}^{23} \sim 1 \times {10}^{24} ) ( 55.8 \times {10}^{3} mg )}{( 6 \times {10}^{23} ) ( {10}^{7} 𝓁 )} \} ,$$

which can be comparable to 0.0034 ppm in seawater and 0.3 ppm in drinking water. It is thus expected that iron ion in either seawater or freshwater can be minimally satisfied to synthesize only chlorophyll-a containing algae cell although much more iron can be required further for protein and cellular reproduction during algal blooms, as conceptually shown in FIG. 2.

Iron in volcanic ashes have been reported in a number of complex forms that include Fe₂O₃, Fe₃O₄, FeCl₂, FeCl₃, FeF₂, FeF₃, FeS, FeS₂, FeSO₄ and Fe₂(SO₄)₃ [Duggen et al., 2010]. Fresh volcanic ash from Japanese Ontake volcano erupted in Sep. 27, 2014, was sampled a week later after the beginning of its eruption to determine concentration of sulfur (Table 2).

TABLE 2
Characteristics of volcanic ashes, volcanic stone, and soil around the world (for FIG. 3).

| | Eruption | Fe | C_{A} | | | | Time³ |
|---|---|---|---|---|---|---|---|
| Volcano | year | (mg/kg) | S (mg/kg) | Fe/S | C_{A}/C_{AO2} | ln C_{A}/C_{AO} | (yr) |
| Mount Ontake, | 2014 | 33,312 | 29,531 | 1.13 | 1 | 0 | 0 |
| Japan | | | | | | | |
| Kasatochi, Alaska | 2008 | 157,942 | 14,572 | 10.8 | 0.493 | −0.70 | 6 |
| Lombok, | 1994 | 60,961 | 701 | 87.0 | 0.0240 | −3.74 | 20 |
| Indonesia | | | | | | | |
| Mount Pinatubo, | 1991 | 73,857 | 385 | 191.8 | 0.0130 | −4.33 | 23 |
| Philippines | | | | | | | |
| Mount St. Helens, | 1980 | 23,235 | 955 | 24.3 | 0.0323 | −3.43 | 34 |
| Washington | | | | | | | |
| Volcanic stone | | | | | | | |
| Mount Baekdu¹ | 969 | 24,368 | 191 | 127.6 | — | — | — |
| Soil | | | | | | | |
| Tongyoung, Korea | — | 26,014 | 1,350 | 19.3 | — | — | — |

Note:
¹Volcanic stone not ash;
²C_{AO} was taken from Ontake; and
³Time elapsed since 2014.
Concentrations of sulfur and iron were measured using an inductively coupled plasma (ICP) (Optima 5300DV, Perkin Elmer).

Volcanic ash samples from 5 other volcanic eruptions, Mount Baekdu of Korea, Mount St. Helens of Washington, Mount Pinatubo of Philippines, Lombok of Indonesia, and Kasatochi of Alaska, were also collected for S concentration. Since the Fe/S ratios of all the aged volcanic ash samples (Table 2) were far greater (10.8˜191.8) than that of the fresh Ontake volcanic ash (1.13), it was evident that volcanic sulfur was diminished likely due to weathering, as shown in FIG. 3.

Correlation between S content and the elapsed time after its eruption of volcanic ash samples is pronounced, except Baekdu volcanic rock (FIG. 3). The relationship between S content and the elapsed time can be modeled as the first order decay [Atkins and Paula, 2010] as

$$( ln \frac{{C}_{A}}{{C}_{AO}} = - kt ) ,$$

and the resulted in the rate constant (k) of 0.1392 yr⁻¹. This rate constant was used to estimate a time necessary for fresh volcanic ash to release S in the surface of the earth, using the equation of

$$\{ t = \frac{ln ( \frac{1}{29 \text{,} 531} )}{- 0.1392 {yr}^{- 1}} \} ,$$

by assuming all four volcanic ash from Mount St. Helens, Mount Pinatubo, Lombok, and Kasatochi had the same initial sulfur concentration that was found in the fresh Ontake volcanic ash. Based on the present data set in FIG. 3, about 74 years was estimated to be required to release S from the fresh volcanic ash left on the oxygenated surface of the earth. Sulfur emitted to the atmosphere is largely from human industrial activities by burning fossil fuels (50˜100 Tg S yr⁻¹), from the ocean via DMS (dimethylsulfide) emissions (16 Tg S yr⁻¹), from subaerial volcanoes (10 Tg S yr⁻¹), from aeolian dust in CaSO₄.2H₂O (8 Tg S yr⁻¹), from forest fire (3 Tg S yr⁻¹) and from coastal ocean and salt marches via COS (carbonyl sulfide) (2.8 Tg S yr⁻¹) (Schrope, 2013). Since most of HNLC regions are far from the industrial complex and residential area, the contribution of fossil fuels and forest fire are negligible. The DMS and COS are internally recycled within the ocean and thus their contributions to the net sulfur cycle in HNLC regions is also largely negligible. The most significant external sources of sulfur compounds to HNLC regions are then the aeolian dust and the subaerial volcanoes. If iron (Fe) in the volcanic ash reacts with dissolved sulfur (S) under steam heating (T>600° C.) conditions (Langmann, 2014), the product will result in insoluble black ferrous sulfide (FeS), which reacts again with acidic hydrogen sulfide (H₂S) to form pyrite (FeS₂) and hydrogen (H₂) (Mcanena, 2011).

In HNLC regions, a buffering capacity of H₂S is much larger than that of non-HNLC regions due to the additional supply of sulfur compounds from volcanic gas (H₂S, SO₂, H₂SO₄) and volcanic ash (S, metalic sulfates), leading to the more abundant product of H₂S not only from the volcanic gas but also from the enhanced sulfate reducing bacteria (SRB). Therefore, both iron and sulfide may be hard to penetrate into the overlying surface ocean but rather be pulled down into the hypoxic deep sediment (˜1,100 m) with abundant Fe (˜565 μM) and H₂S (˜150 μM), as observed by Aquilina et al. (2014) in the deep ocean of the Southern Ocean, the largest HNLC region.

Volcanic gases are commonly composed in the order of H₂O (37-97%), CO₂, SO₂ (0.50-11.8%), H₂, CO, H₂S (0.04-0.68%), HCl, and HF. For example, continuous volcanic eruptions at Mt. Erebus (3,794 m) in Antarctica has resulted in excess sulfate (SO₄²⁻) concentrations of 85.7 ppb at Ross Ice Shelf (Dixon et al., 2005).

FIG. 4 shows that volcanic S compounds (S, SO₂, SO₃, H₂S, H₂SO₄, sulfates) induce bio-available Fe²⁺_{(aq)} toward rapid (ΔG°ᵣ=−1207.719 kj·mol⁻¹ between FeOOH and H₂S) mackinawite (FeS) and slow (ΔG°ᵣ=−30.7648 between FeS and H₂S, and −30 kj·mol⁻¹ between FeS and S°) pyrite (FeS₂) sedimentations (Fanning et al., 2012) in HNLC regions (Aquilina et al., 2014) without releasing Fe²⁺_{(aq)} to phytoplankton during pyrite (FeS₂) formation, except for the iron- and sulfur-oxidizing bacteria such as Acidithiobacillus ferrooxidans, Alicyclobacillus, and Sulfobacillus, living in pyrite deposits to metabolize ferrous iron and sulfur and producing sulfuric acid. Such an exceptional pyrite oxidation has been observed at the coastal sulfidic mine in northern Chile with extreme acidity (pH=1-4) and high salinity (10-20 cm thick salts) (Korehi et al., 2013). Therefore, HNLC regions, compared to non-HNLC and non-Fe limited regions [Karl, 1968], are big reservoirs of S compounds from extensive volcanic eruptions to induce sedimentary FeS and FeS₂ with Fe-limited (4×10⁻⁶ ppm) (0.07 nmol L⁻¹) oceans (Boyd et al., 2001).

Block diagram leading to HNLC regions is schematically simplified in FIG. 5. As shown in FIG. 6, algae utilize the dissolved iron, Fe²⁺_{(aq)} with competition of insoluble FeS/FeS₂, the latter being significant if the volcanic activity is stronger for the sulfur contribution than the desert contribution for iron. Soluble Fe sulfates in FIG. 6 are FeSO₄, (Fe)₂(SO₄)₃, (NH₄)₂Fe(SO₄)₂ and insoluble Fe sulfides are FeS and FeS₂, while soluble non-Fe sulfates are Al₂(SO₄)₃, NH₄HSO₄, (NH₄)₂SO₄, (NH₄)₂SO₃, BeSO₄, CdSO₄, CuSO₄, MgSO₄, MnSO₄, NiSO₄, KHSO₄, Pb₂SO₄, Na₂SO₄ and NaS₂O₃. Insoluble non-Fe sulfates are Ag₂SO₄, BaSO₄, PbSO₄, Hg₂SO₄, RdSO₄ and SrSO₄, while soluble sulfide is H₂S and insoluble sulfides are CdS, CuS, PbS and PoS.

The more H₂S available from either the volcanic gas and sulfur oxidation, or soluble sulfates through sulfate reducing bacteria and soluble sulfides, the more sedimentation occurs in the forms of FeS and FeS₂. Therefore, it can be seen that the volcanic eruption enhances the formation of FeS and FeS₂, which allows less and less Fe available to algae to be iron limited condition of “LC” (low-chlorophyll). On the other hand, nutrients such as nitrate, phosphate and silicate are fairly soluble to be utilized by algae. However, if Fe is limited, the growth of algae is retarded and thus nutrients are less utilized and further enriched to be “HN” (high-nutrient). Since phytoplankton require sulfur for biosynthesis of two amino acids-cysteine and methionine and some thylakoid lipids, the presences of 75% clay and 25% volcanic ash with ample Fe and aerated S compounds (C75 in FIG. 7) promoted the phytoplankton growth, as observed in eight hot fish-abundant oceans of LNHC regions (Table 3). In FIG. 7, the growth curves with 4 similarity experiments for all 4 ecosystems conditions of HNHC (high nutrient, high chlorophyll), HNLC (high nutrient, low chlorophyll), LNHC (low nutrient, high chlorophyll), LNLC (low nutrient, low chlorophyll) (Table 3) were shown after three reproducible measurements expressed by error bar for the standard deviation at each point. JM medium without Fe was used as the base medium for HNLC (−Fe in FIG. 7) while 0.1 g of Ontake volcanic ash (100% volcanic ash) was added to 150 ml JM medium without Fe for LNLC (V100 in FIG. 7). A mixture of 0.075 g of Tongyoung clay (26,014 mg Fe/kg and 1,350 mg S/kg) and 0.025 g of Ontake volcanic ash (33,312 mg Fe/kg and 29,531 mg S/kg) (Table 2), was added to 150 ml JM medium without Fe for LNHC (C75 in FIG. 7) while JM medium with its own Fe was used for HNHC (+Fe in FIG. 7). The 100% volcanic ash (V100) showed low growth of phytoplankton, similar to LNLC regions. The base medium without Fe showed the lowest growth, similar to HNLC regions. The present similarity experiments in FIG. 7 were in good agreement with the phytoplankton productivity of oceanic regions in the sequence of HNHC>LNHC>LNLC>HNLC. The present results of bottle experiments showed similar growth patterns for HNHC “with iron” and ones for HNLC “without iron” as was demonstrated by Martin et al., (1991). Three times of batch cultures were repeated to obtain negligible error bar for each measurement with standard deviation (FIG. 7).

TABLE 3
Oceanic regions with relative accumulation rates of iron (Fe) from desert
and sulfur (S) from volcano.

| | Oceanic Location | | |
|---|---|---|---|
| | (Relative | Major Nutrient Sources | |
| | Accumulation Rates | | Volcano (S) |
| Region | of Fe and S) | Desert (Fe) | (Number) |
| HNLC | 1. Southern Ocean | 1. Austalian/ | 1. Erebus |
| | 2. Equatorial Pacific | Patagonian/ | (Antarctica) (19)/ |
| | | Kalahari/ | Huaynaputina (Peru) |
| | | Antarctic Polar | (29)/Hudson |
| | | 2. Gobi/Atacama | (Chile) (137) |
| | | 3. Gobi | 2. Huaynaputina |
| | | | (Peru) (29)/Hudson |
| | | | (Chile) (137)/ |
| | | | Cotopaxi (Ecuador) |
| | | | (43) |
| | | | Galapagos Islands |
| | | | (Ecuador) (12) |
| | | | 3. Aleutian 40)/ |
| | | | Augustine (USA) |
| | | | (15)/Kamchatka |
| | | | (Russia) (29) |
| | 3. Subarctic Pacific | | |
| | $\begin{matrix}( \frac{d Fe}{dt} < 0 , \frac{dS}{dt} ≫ 0 ) \\ ( \vert \frac{d Fe}{dt} \vert ≪ \vert \frac{d S}{dt} \vert )\end{matrix}$ | | |
| LNLC | 1. Ryu Kyu/Izu- | 1. Gobi | 1. Japan (108) |
| | Bonin Arc | 2. (Gobi) | 2. Hawaii (15) |
| | 2. Hawaii | 3. (Gobi) | 3. Anatahan (USA) |
| | 3. western North | 4. Highlands of | 4. Iceland (130) |
| | Pacific Subtropical | volcanic desert | |
| | Gyre/Guam | | |
| | 4. Iceland | | |
| | $\begin{matrix}( \frac{d Fe}{dt} < 0 , \frac{dS}{dt} > 0 ) \\ ( \vert \frac{d Fe}{dt} \vert < \vert \frac{d S}{dt} \vert )\end{matrix}$ | | |
| HNHC | Benguela upwelling | Kalahari, Namib | None active but |
| | system | | extinct; Angola (0), |
| | | | Namibia (1), South |
| | | | Africa (4) |
| | $\begin{matrix}( \frac{d Fe}{dt} ≫ 0 , \frac{dS}{dt} < 0 ) \\ ( \vert \frac{d Fe}{dt} \vert ≫ \vert \frac{d S}{dt} \vert )\end{matrix}$ | | |
| LNHC | 1. Pacific coast of | 1. Chihuahuan, | 1. Barcena, Socorro |
| | Mexico | Sonoran, Mojave | and 9 others |
| | 2. Northeast Pacific | 2. Gobi, Great | 2. Augustine (15), |
| | 3. Northwest Pacific | Basin | Kasatochi, Redoubt |
| | 4. Northeastern | 3. Gobi | (13) Pavlof(40), |
| | Canada | 4. Arctic, Sahara | Cleveland (19) |
| | 5. Peruvian coast | 5. Patagonian, | 3. Hokkaido (17), |
| | 6. New Zealand | Atacama | Honshu (46), |
| | 7. Southern Africa | 6. Great Victoria, | 4. Greenland, |
| | 8. The Antarctic | Great Sandy, | Iceland, |
| | | Gibson, Simpson | Newfoundland |
| | | 7. Kalahari, Namib | Seamounts, Fogo |
| | | 8. Antarctic, Great | Seamounts |
| | | Victoria, Great | 5. Peru (29) and |
| | | Sandy, Gibson, | Chile (137) |
| | | Simpson, | 6. White Island, |
| | | Patagonian, | Kermadec Islands |
| | | Atacama, | 7. Madagascar (5), |
| | | Kalahari, Namib | Mozambique(1), |
| | | | Tanzania(22), South |
| | | | Africa (4) |
| | | | 8. Erebus (19) |
| | $\begin{matrix}( \frac{d Fe}{dt} ≫ 0 , \frac{dS}{dt} > 0 ) \\ ( \vert \frac{d Fe}{dt} \vert > \vert \frac{d S}{dt} \vert )\end{matrix}$ | | |

Since nutrients are carried by winds and ocean currents (FIG. 8), LNLC regions such as Iceland Basin (Nielsdottir et al., 2009) and southern Omani coast (Naqvi et al., 2010) showed HNLC characteristics seasonally, while HNLC regions such as South Georgia, Crozet and Kerguelen Islands in the Southern Ocean showed HNHC characteristics during austral summer (Venables and Moore, 2010).

The effect of S compounds upon the growth of phytoplankton associated with Fe was experimentally examined in the present work. H₂S generated by decomposed white of egg was prepared to see its removal of Fe from JM medium with EDTA-Fe as iron sulfides (FeS/FeS₂) sedimentations. FIG. 9 showed the growth of phytoplankton at JM medium with and without various volumes of decomposed egg solution.

Due to the addition of filtered decomposed egg solution producing dissolved hydrogen sulfide (H₂S) to the present culture media, cell density in 10⁴ cells/ml was measured (FIG. 9) by microscope to avoid the problem of turbidity instead of measuring absorbance at 660 nm (FIG. 7). It was evident that the cell growth was retarded as increasing the volume of decomposed egg solution from 0 ml (JM+0 in FIG. 9), 10 ml (JM+10 ml in FIG. 9), 30 ml (JM+30 ml in FIG. 9), 40 ml (JM+40 ml in FIG. 9) among total balanced 150 ml culture JM media. The highest growth curve was observed when there was no other addition except JM media itself with EDTA-Fe (iron-replenished). As increasing dissolved H₂S amounts by increasing the volume of decomposed egg solution, dissolved H₂S reacted with Fe of JM media in EDTA-Fe to sediment as iron sulfides (FeS/FeS₂). There was a color change from yellow of egg solution to brown FeS/FeS₂ upon addition of JM media with EDTA-Fe to the decomposed egg solution producing H₂S. As volume of decomposed egg solution was reached to 40 ml (28%), the resultant cell growth curve was overlapped with the case without its own Fe (JM-Fe in FIG. 9), which implied that 40 ml decomposed egg solution with dissolved H₂S was good enough to deprive remained 110 ml JM media as EDTA-Fe of all the Fe. FIG. 9 clearly indicated that dissolved H₂S from decomposed egg solution reacted with Fe in JM media to be iron limited. The present result in FIG. 9 supported the experimental observation of similarity experiments in FIG. 7. Therefore, HNLC regions were caused by locking iron (Fe) with sulfur (S) compounds including hydrogen sulfide (H₂S) from sub-aerial or underwater active volcanoes to form insoluble iron sulfides (FeS and FeS₂) for iron limited low chlorophyll condition.

Oceans with iron limitation can be thus categorized by 4 regions depending upon the relative rates of accumulation for iron (F) and sulfur (S),

$$\frac{( dS - dFe )}{dt} ,$$

in the large order of LNLC, HNLC, LNHC and HNHC, as summarized in Tables 3 and 4.

TABLE 4
Accumulation rates of iron and sulfur compounds for 4 cases of regions.
(−; descending, −−; significantly descending, +; ascending, ++;
significantly ascending)

| | | Accumulation Rate | | | |
|---|---|---|---|---|---|
| Regions | | Iron (dFe/dt) | Sulfur (dS/dt) | $\frac{( dS - dFe )}{dt}$ | Relative Magnitude |
| LC | HNLC | + | ++ | + | $\begin{matrix}0 > \frac{d Fe}{dt} , \frac{dS}{dt} ≫ 0 \\ \vert \frac{d Fe}{dt} \vert ≪ \vert \frac{d S}{dt} \vert\end{matrix}$ |
| | LNLC | − | ++ | ++ | $\begin{matrix}0 > \frac{d Fe}{dt} , \frac{dS}{dt} ≫ 0 \\ \vert \frac{d Fe}{dt} \vert < \vert \frac{d S}{dt} \vert\end{matrix}$ |
| HC | HNHC | ++ | − | −− | $\begin{matrix}0 ≪ \frac{d Fe}{dt} , \frac{dS}{dt} < 0 \\ \vert \frac{d Fe}{dt} \vert ≫ \vert \frac{d S}{dt} \vert\end{matrix}$ |
| | LNHC | ++ | + | − | $\begin{matrix}0 ≪ \frac{d Fe}{dt} , \frac{dS}{dt} > 0 \\ \vert \frac{d Fe}{dt} \vert > \vert \frac{d S}{dt} \vert\end{matrix}$ |

It is expected that LNLC regions can be temporarily changed to LNHC regions although not for a long time due to the limited amount of the Fe-replete composite for the large-scale iron fertilization. It is thus postulated that the future iron enrichment experiment can be carried out either in HNLC, as done so far during the last 20 years, or in LNLC regions, most preferably in the boundary of Mariana Islands, Hi., Guam of the U.S. Territory and Iceland, as long as some sort of the external iron supply is followed in large scale along with minor techniques allowing the Fe-replete composite to stay within 100 m deep surface for diatoms assimilation of iron.

Note that iron is available mainly from 3 sources of desert, volcano and upwelling while sulfur is available from 2 sources of volcano and desert, the latter being negligible due to its sulfur wash-out for long time by rainfall and weathering. Note also that the Antarctic is not only HNLC regions of the Southern Ocean but also one of 8 major great fishing areas of LNHC. This duality can be caused by the copresence of Continental deserts and volcanos. The carriers of the inorganic nutrient pool in FIG. 8 are Winds and Currents, which have seasonal variations. Therefore, 4 cases of HNLC, LNLC, HNHC, and LNHC can have their own variations with seasons. Sulfate-reducing bacteria (SRB) are widely distributed in deep water and sediments of lakes, rivers, and oceans. With the capacity to use sulfate, thiosulfate or even elemental sulfur as electron receptors instead of oxygen in their respiratory chain, they participated in the recycle of elemental sulfur in nature. SRB produces H₂S from soluble FeSO₄ or Fe₂(SO₄)₃, which is ultimately transformed to insoluble FeS and FeS₂. Therefore, H₂S depletes Fe and lead to the Fe limited zone. In non-HNLC regions, not many sulfur compounds are present except those from algal or animal decomposition. In HNLC regions, however, many sulfur compound are supplied from volcanoes. Thus, there were abundant H₂S pool as observed in the Southern Ocean. On the contrary, there can be not many H₂S in non-HNLC due to lack of external supply of sulfur compounds. Abundant SRB in the deep ocean (˜1,100 m) of HNLC regions (Aquilina, 2014) might be the sign of the facilitated sedimentation of Fe starved zone in HNLC. There can be a continuous sedimentation of Fe²⁺_{(aq)} in forms of FeS and FeS₂ by H₂S pool, produced by SRB under hypoxic conditions such as in swamps or dead zones of lakes and oceans. Therefore, most of Fe supplied to HNLC regions, internally by algal and bacterial decompositions or externally by aeolian dust and volcanic ash, will be eventually converted to insoluble FeS and FeS₂ in the hypoxic deep ocean of HNLC regions unless assimilated to phytoplankton within the surface distance of about 100 m or so. In HNLC regions, Fe will be supplied by either wind-driven upwelling (as is at the Gulf of Alaska in the Subarctic Pacific and at the Galapagos Islands in the Equatorial Pacific) or temperature-driven hydrothermal vent (as is in the Southern Ocean). Regardless of HNLC or non-HNLC regions, additional driving force of Fe flux (amount per unit area per unit time) will be available from the concentration gradient of dissolved oxygen between the hypoxic deep ocean with plenty of decomposed Fe as source of Fe and the oxic surface ocean with Fe-starved algae as sink of Fe. In HNLC, however, the amount of Fe available to algae was far less (0.000004 ppm) than that in non-HNLC regions (0.0034 ppm) due to much more sedimentations of FeS and FeS₂ by relatively abundant supply of sulfur from the volcanic eruptions in HNLC compared to the input of iron from the desert dust. In Table 5, flux and gradient with source and sink in HNLC regions were summarized, which implied that there could be simultaneously momentum, heat and mass fluxes in HNLC regions.

TABLE 5
Source(+) and sink(−) of fluxes in the surface and deep oceans of HNLC regions.

| | | | Mass | | | | | |
|---|---|---|---|---|---|---|---|---|
| | Momentum | | | | | | | Sulfate |
| | Current | Heat | Dissolved | | | | | Reducing |
| Flux | flow rate | Temperature | Oxygen | | | | | Bacteria |
| Gradient | (ν) | (T) | (DO) | Fe²⁺_{(aq)} | FeS | H₂S | Algae | (SRB) |
| Surface | + | + | + | − | − | − | + | 1) |
| Ocean | | | | | | | | − |
| Deep | − | − | − | + | + | + | 3) | 2) |
| Ocean | | | | | | | − | + |

Note;
1) SRB survives only one day under air exposure.
2) 10⁸~10⁹ cells · mL⁻¹
3) dead or sinking algae

The hypoxic condition in the deep ocean allowed the sulfate-reducing bacteria (SRB) (Desulfovibrio˜40 μm), surviving only one day in air, to produce H₂S and Fe²⁺, the latter being partly engulfed by bacteria for their own concentrated growth (10⁸˜10⁹ cells·Ml⁻¹). SRB produced H₂S and metal ions along with Fe²⁺ from high sulfates in the hypoxic water, while HNLC regions with extensive volcanic eruptions were enriched with sulfur compounds of S, H₂S, SO₂, H₂SO₄, and sulfates with FeSO₄ to produce more H₂S and Fe²⁺, which might lock and hold more Fe²⁺ in forms of FeS and FeS₂ to be less Fe²⁺ available to algae in the surface ocean. Besides, the bacterial growth in the hypoxic water was further enhanced by the abundant supply of Fe²⁺ from iron sulfate through their own sulfate-reducing activity. As the more sulfate is available from volcanic eruptions, the more H₂S is produced in HNLC regions, which leads to locking more Fe²⁺ to the sediment in FeS and FeS₂ precipitates. Therefore, HNLC regions are Fe-limited due to the relatively abundant supply of sulfur compounds from the extensive volcanic eruptions. Especially, the Southern Ocean with fast (˜4 km per hour) and the largest volumetric flow rate (1.47×10⁸ m³ per second at Tasmania) of the Antarctic Circumpolar Current and yearly continuous volcanic eruptions at Mt. Erebus allow a lot of sulfur compounds with fast dissipation into its deep ocean, associated with leaving the highest nutrients (N, P, Si) among global HNLC regions to be “high nutrients” while Fe is mainly sedimented in FeS and FeS₂ by enriched pools of H₂S and SRB to be Fe-limited or “low chlorophyll”.

### SUMMARY

The present invention may enable us to decide the appropriate location for the large-scale iron enrichment experiment to reduce the atmospheric CO₂ with several criteria as below.

As the future candidate of optimal locations, Hook Ridge in the Central Basin of the Bransfield Strait of the Southern Ocean and Shag Rocks (200×50 km) of South Geogia in northern Scotia Sea are suggested by the following reasons.

1) Volcanic Aspects to Avoid the Sulfur Compounds.
Not over the boundaries of the Earth plate (for Hook Ridge), but just outside of northern Scotia plate (for Shag Rocks)
Far from active volcanoes and earthquakes (for Shag Rocks)
Low concentrations of sulfur compounds (S⁰, SO₃²⁻, SO₄²⁻, H₂S, SO₂) to minimize iron sulfide formation,

2) Iron Input as Many as Possible for Algal Blooms.
Downwind region of the Patagonian and Chile deserts for aeolian supply of minerals with iron (for Shag Rocks)
Near to rocky islands covered partly with ice for self aeolian dust flux input and nutrient enriched ice melt (for Shag Rocks)
Wind-driven upwelling, density-driven vortex mixing, and previous volcanic eruption with abundant iron sediments due to submarine volcanic eruption as a pool of dissolved iron in the pore deep ocean (for Hook Ridge)
Not bulk scale additions of direct iron or iron sulfate, but deploying natural clays or soils available nearby islands with possible content of iron in the range of 7 to 18 wt % iron in west Australia or 3.5 to 6 wt %, as observed elsewhere in the Continents, along with volcanic ash desulfurized by rainfall and weathering for long time of maximal 74 years,

3) High Momentum Flux for Fast Dispersion Around the Experimental Zone.
Cold and fast Weddell Sea Deep Water passes through to meet the warm waters of the Subarctic, creating a zone of upwelling nutrients (for Shag Rocks)
Located in-between the South America and the Antarctic with narrowest Drake Passage providing the Antarctic Circumpolar Current with high linear flow velocity (˜4 km per hour, ν) and the largest ocean current (1.25×10⁵ m³ per second) for fast deployment of the Fe-replete complex (m_{A}) over wide oceanic surface area with high momentum flux (m_{A}·ν) in large scale iron fertilization,

4) Nutrients for Effective Algal Bloom to be Near “High Chlorophyll (HC)”
Region where cyanobacterium Synechoccus live as initial efficient grazer of iron
Abundant coccolithophorids and silicoflagellates are dominated in Weddell Sea, which passes through (for Shag Rocks)
High concentration of silica or silicic acid for proper growth of diatoms such as Corethron criophilum, Chaetoceros neglectus, Chaetoceros dichaeta (de Baar et al., 1990), which are invulnerable to predation by zooplankton and sink rapidly (0.96 m d⁻¹) upon death for efficient sequestration of atmospheric CO₂
A place where the Antarctic krill and humpback whale are currently present with stable food webs ecosystem,

5) Environmental Aspects to Increase the Probability of Successful Iron Enrichment Experiment
Not far from sources of search and rescue
Experimental period can be the duration between November and April or preferably January for high irradiance and warm water temperature with high ice melt for phytoplankton bloom.

### BRIEF DESCRIPTION OF THE DRAWINGS

FIG. 1 is a diagram illustrating that Fe may be released from the sediments as more available reduced Fe²⁺ prior to algal blooms.

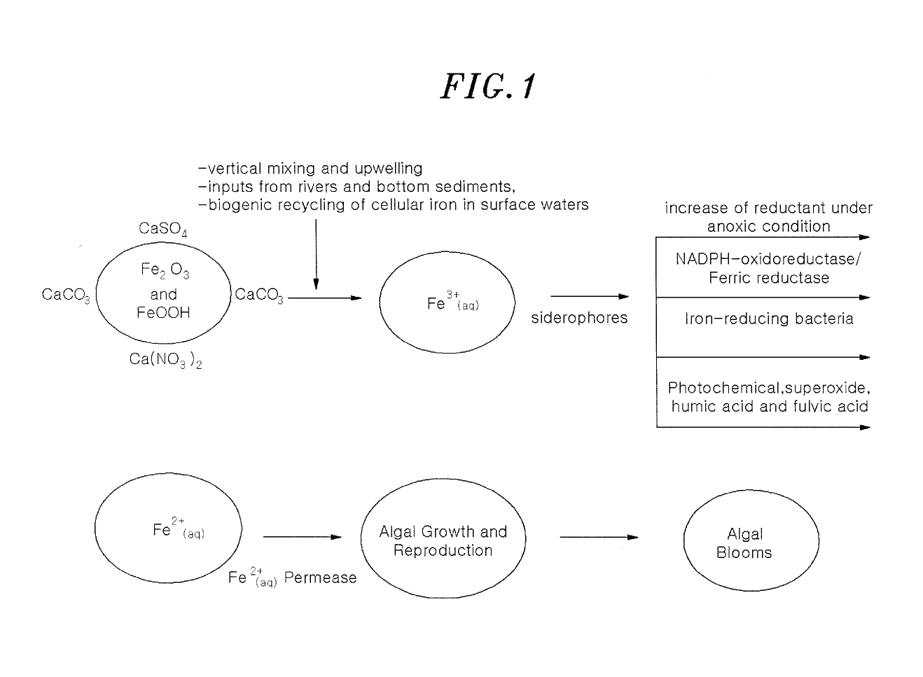

FIG. 2 is a diagram illustrating that iron ion in either seawater or freshwater can be minimally satisfied to synthesize chlorophyll-a containing algae cell.

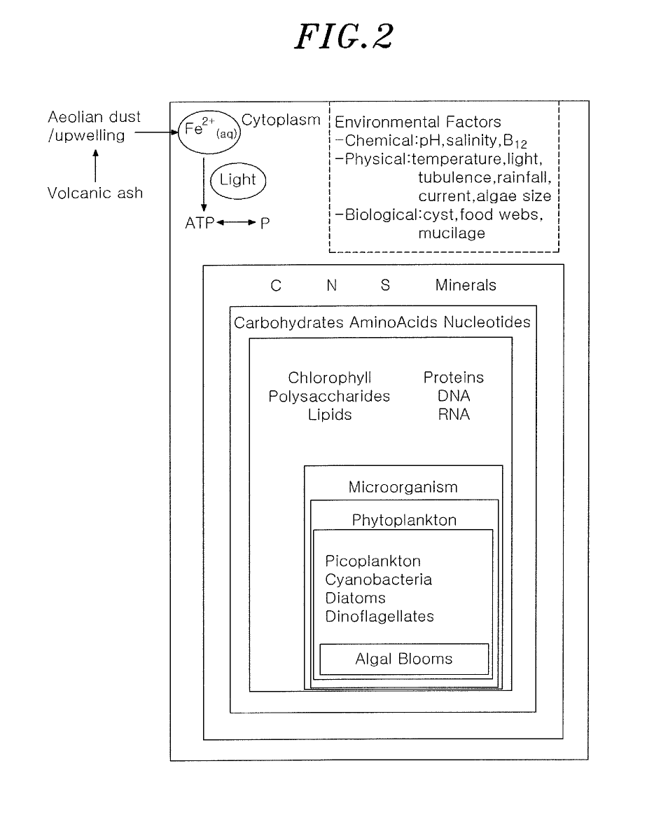

FIG. 3 is the first order decay of volcanic sulfur to estimate the maximal time of 74 years for desulfurization of the volcanogenic sulfur available from various volcanic ashes (Table 2) since the volcanic eruption.

FIG. 4 is pathways of iron from aeolian dust and sulfur from volcano prior to being consumed by phytoplankton in HNLC regions.

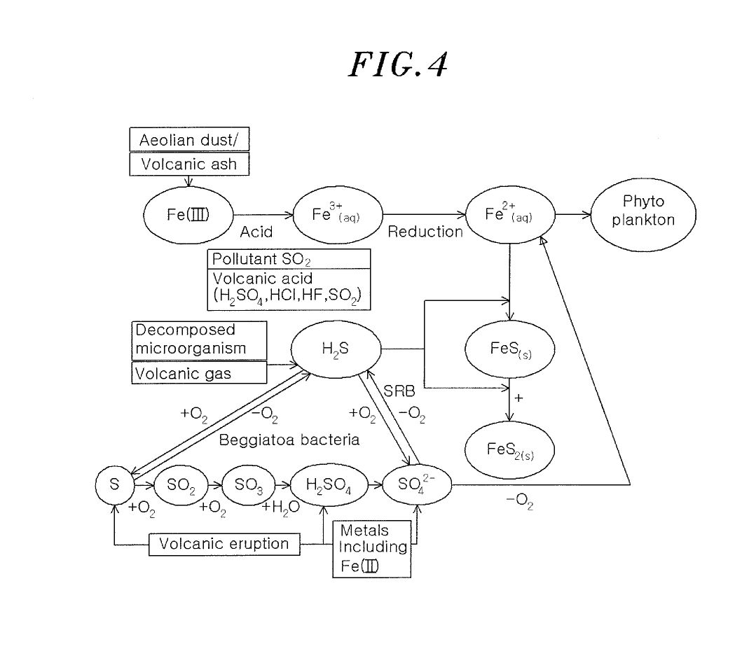

FIG. 5 is a block diagram leading to HNLC regions.

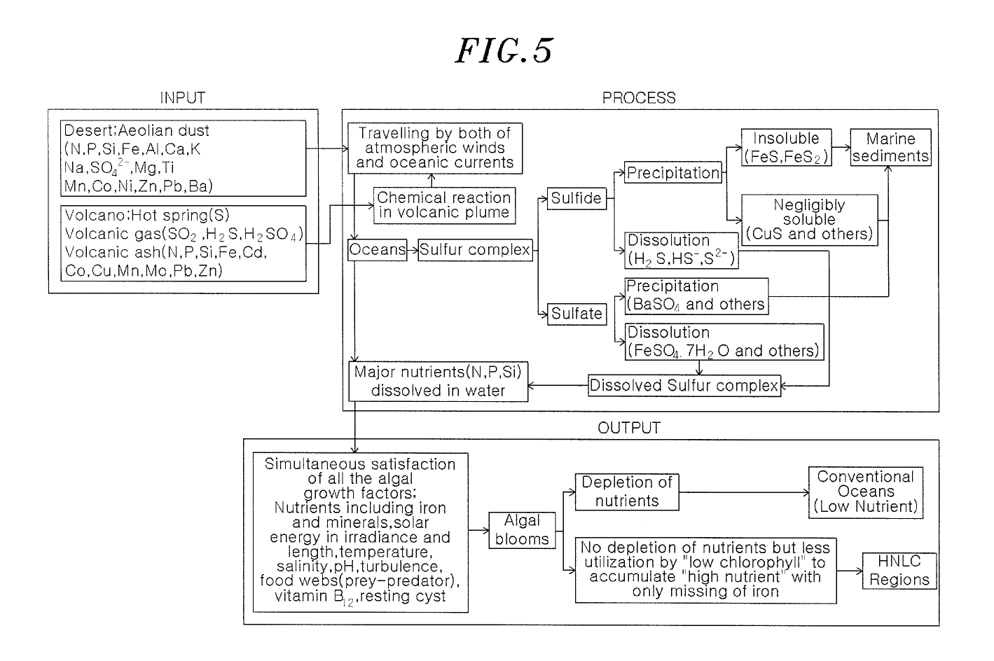

FIG. 6 is a diagram illustrating that algae utilize the dissolved iron, Fe²⁺_{(aq)} with competition of insoluble FeS/FeS₂, the latter being significant if the volcanic activity is stronger for the sulfur contribution than the desert contribution for iron.

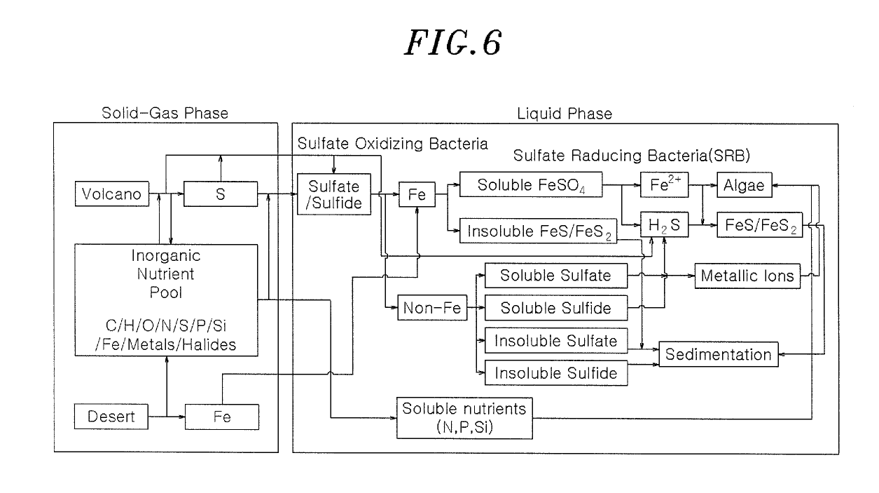

FIG. 7 is aerobic culture of Chlorella vulgaris with various JM media; with its own Fe (+Fe, -□-) HNHC, mixture of 75% clay and 25% volcanic ash (C75, -◯-) LNHC, fresh 100% volcanic ash (V100, -Δ-) LNLC, without its own Fe (−Fe, -⋄-) HNLC. Standard deviation was expressed by each error bar for three measurements with excellent reproducibility.

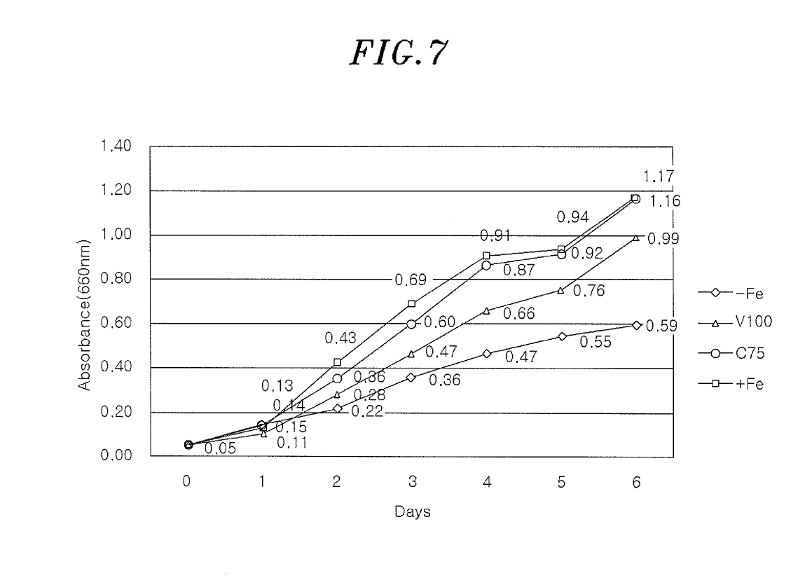

FIG. 8 is a diagram illustrating that the carriers of the inorganic nutrient pool are winds and currents, which have seasonal variations.

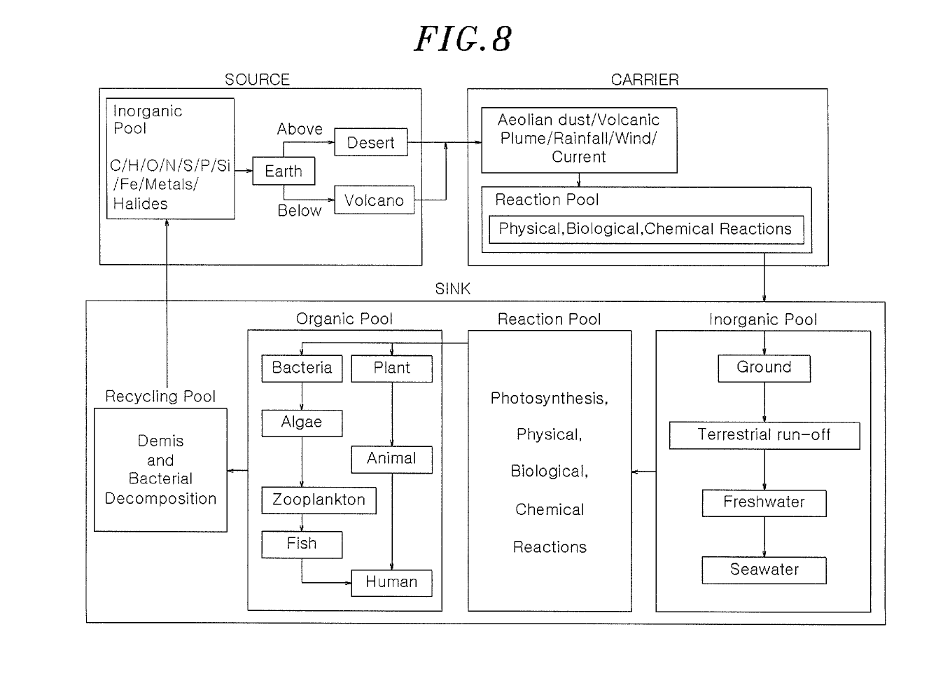

FIG. 9 is aerobic culture of Chlorella vulgaris with various JM media; with its own Fe and without decomposed egg solution (0%) (JM+0, -+-) HNHC, mixture of 140 ml JM and 10 ml decomposed egg solution (7%) (JM+10 ml, -□-) LNHC, 120 ml JM and 30 ml decomposed egg solution (21%) (JM+30 ml, -Δ-) LNLC, 110 ml JM and 40 ml decomposed solution (28%) (JM+40 ml, -◯-) HNLC, and without its own Fe (JM-Fe, -x-) HNLC. Standard deviation was expressed by each error bar for three measurements with excellent reproducibility.

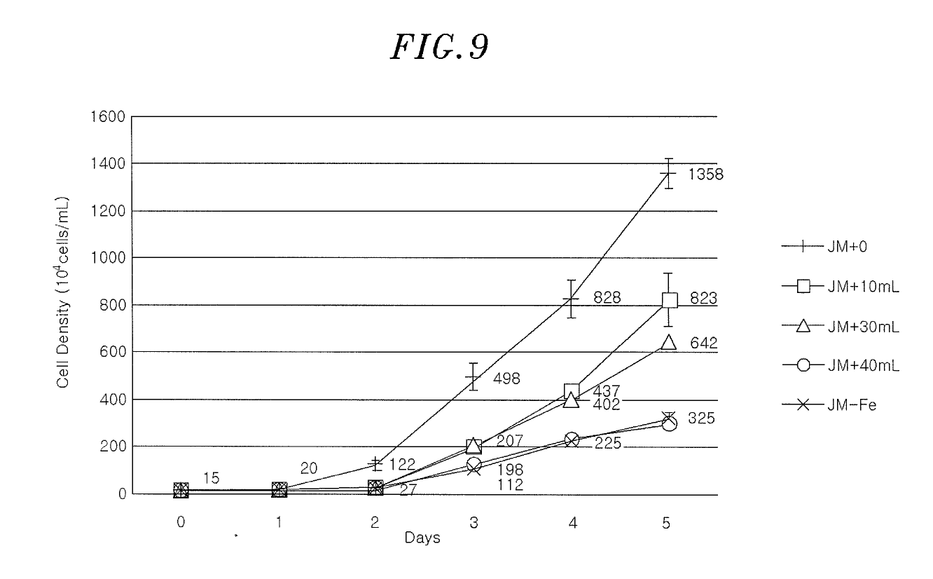

### DETAILED DESCRIPTION

There can be a few possible low chlorophyll (LC) of LNLC regions around the world in addition to the current well-known HNLC regions. Iceland, Mariana Islands-Guam, North Pacific Subtropical Gyre and Hawaii are suggested as LC regions due to abundant sulfur compounds available from either submarine of subaerial volcanic eruptions to pull down the iron in forms of FeS and FeS₂ to the ocean sediment and further more its oceanic dispersion flow pattern is blocked or surrounded by Winds and Currents to be isolated from neighboring oceans. Such LNLC regions can be temporalily turned to LNHC regions so long as continuous supply of iron in large scale is provided, which may allow not only the sequestration of atmospheric CO₂ but also the great fishery. Iceland is located in-between Arctic Ocean and North Atlantic Ocean of Mid-Atlantic Ridge with division between European and North American tectonic plates. The island has 130 active volcanoes with downward cold Currents (East Greenland and East Icelandic) and upward warm Currents (North Atlantic and Icelandic) along with Winds (Easterly/Westerly/Icelandic Low/North Atlantic Oscillation) and even dust storms from Southern Iceland. Bioassay experiment by Nielsdóttir (2009) showed nitrate (2.83˜5.00 μM), silicic acid (0.03˜0.70 μM) and chlorophyll (0.24˜0.58 μgl⁻¹), which is close to those of the Subarctic Pacific in Table 1. As for the Mariana Islands, Japan has 108 active and extinct volcanoes in brackets with two tracks, one is Hokkaido (17), Honshu (46), Izu Islands (12), others (12), and another is Kyushu (10) and Nansei Islands (11). The tectonic plates surrounding Japan are Pacific, Philippine Sea and Okinawa plates. The volcanoes from Ryukyu Arc and the Izu-Bonin-Mariana Arc embrace together partly western Pacific Ocean and Philippine Sea up to Mariana Islands. Japan has downward cold Current of Oyashio from Kamchatka and upward transverse warm Currents of Kuroshio and North Equatorial while strong typhoon pushes upwards during the summer. Therefore, there can be a convergence zone in front of Osaka surrounded clockwisely by Zamami Island (famous for humpback whale watching), Nanpo Islands, Mariana Islands, Okinawa Islands and Kyushu volcanoes. Lin et al. (2011) showed the fertilization potential near the Anatahan volcano (146° E, 16° N) in the Northern Mariana Islands of western North Pacific Subtropical Gyre with the concentrations of nitrate (0.042 μM), phosphate (0.003 μM) and iron (0.002 μM) to claim the most oligotrophic LNLC ocean deserts on Earth. Due to the political conflicts in the Northern Mariana Islands and its too close to the Anatahan volcano, the future fertilization experiment can be considered at somewhere near to U. S Territory of Guam.

Hawaiian volcanoes are located in the middle of the Pacific plate while Hawaiian Hotspot between the Hawaiian Ridge and Emperor Seamount chain is composed of more than 80 large volcanoes, which shows the stepwise development of volcanic activity such as submarine preshield stage (Loihi Seamount), shield stage with caldera while submerged, explosive subphase with volcanic ash, subaerial subphase (currently active Hawaiian volcanoes), and finally postshield stage (atoll and eventually seamount). Hawaiian archipelago has 15 active volcanoes with opposite directional currents (westerly North Equatorial and easterly Equatorial Countercurrent) in the North Pacific Gyre and NE Trade Wind. The extent of LNLC characteristics can be significant in Iceland since Iceland has much more active volcanoes (130) even excluding neiboring Greenland (500) than those of Japan (108) and Hawaii (15), and more surrounded by Currents and Winds to be partly isolated from the Arctic Ocean and the North Atlantic Ocean.

Since the dissolved iron is engulfed by picoplankton to be grazed by diatoms and subsequently by copepods, krill, and finally by small fish or by whale. Humpback whale with worldwide population of about 10,000˜15,000 feeds krill, copepods and small fish. Humpback whale has been observed not only in 3 HNLC regions of the Subarctic Pacific (Alaska), the Equatorial Pacific (Galapagos) and the Southern Ocean (Drake Passage, South Georgia), Antarctic Peninsula (south of Cape Horn) but also in other 4 locations of Iceland (Snaefellsnes Peninsula), Japan (Zamami), Guam, and Hawaii (Maui). It can be thus postulated that humpback whale is a good biomarker for the location of the future iron enrichment experiment. In other words, such an iron experiment may be better to be carried out somewhere humpback whales feed and breed since the fertilized iron can be fed by the phytoplankton to be grazed by copepod and krill, and eventually by humpback whale. July is usually the mating season for Southern Hemisphere humpback whales, with births occurring in June of the subsequent year. A calf is generally strong enough to migrate with its mother at three months old. Since humpback whale feeds krill and small fish at the Antarctic during the winter while it breeds at the tropical or subtropical oceans during the summer, it is suggested to start the iron fertilization experiment during the early summer of January with warm coastal temperature (˜3˜15° C.) and sufficient irradiance. At the time when humpback returns to the Southern Ocean after long journey from the Northern Hemisphere tropical or subtropical oceans, the iron stimulated area in someplace of the Southern Ocean may have already algal bloomed with friendly eco-system community of heterotropic bacteria, picoeukaryotes and picoplankton, diatoms, copepods and krill if the intended iron enrichment experiment in large scale is successful.

In order to differentiate the global ocean into four oceanic regions in terms of accumulation rates of Fe and S, the accumulation rate of Fe in the ocean

$$( \frac{dFe}{dt} ) ,$$

is given as:

$$\frac{dFe}{dt} = {( \dot{F e} )}_{in} - {( \dot{F e} )}_{out} + {( \dot{F e} )}_{gen} - {( \dot{F e} )}_{con} - {( \dot{F e} )}_{rxn}$$

where

(\dot{F}e)ᵢₙ=the input rate of Fe (nmol m⁻²d⁻¹) from desert dust, volcanic ash, rivers and bottom sediments,

(\dot{F}e)ₒᵤₜ=the output rate of Fe during FeCycle is negligible due to short term (hours) biological iron uptake [McKey et al., 2005],

(\dot{F}e)_{gen}=the generation rate of Fe from vertical mixing, upwelling and biogenic recycling of cellular iron within the ocean [McKey et al., 2005],

(\dot{F}e)_{con}=the consumption rate of Fe by phytoplankton assimilation,

(\dot{F})ᵣₓₙ=the removal term for dissolved Fe by scavenging on the sinking particulate matter and chemical reaction rate of Fe with volcanic S compounds as sedimentary FeS and FeS₂.

Oceans are subdivided into four regions based on the amounts of nutrient and chlorophyll; HNLC (high-nutrient, low-chlorophyll), HNHC (high-nutrient, high-chlorophyll), LNLC (low-nutrient, low-chlorophyll), and LNHC (low-nutrient, high-chlorophyll). It is assumed that

$$\frac{dFe}{dt} ≫ 0$$

for HC (high-chlorophyll) regions (as is in HNHC and LNHC) if Fe supplied largely from deserts and upwelling. When

$$\frac{dFe}{dt} < 0$$

and the accumulation rate of volcanic S compounds,

$$\frac{dS}{dt} ≫ 0$$

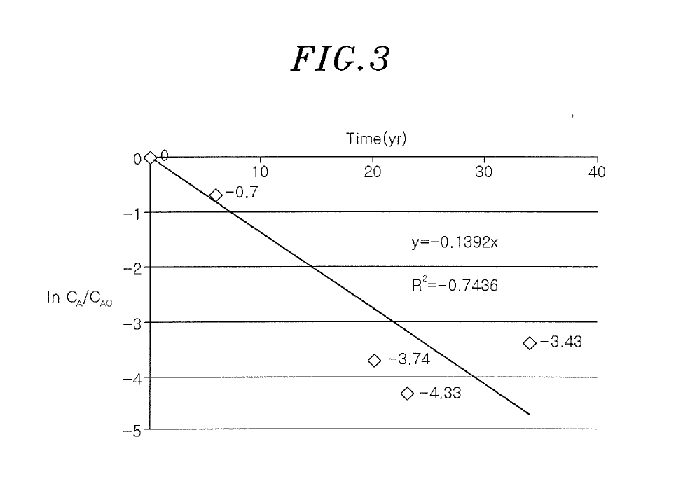

for LC (low-chlorophyll) regions (as is in HNLC and LNLC) are satisfied if Fe is rarely replenished from deserts and subsurface water upwelling while volcanic S compounds are abundant. We present a review of the four oceanic regions listed above are presented here. 1) The southern Omani coast was studied to evaluate HNLC characteristics during the late Southwest Monsoon (August˜September) [Naqvi et al., 2010]. Fe-replete dusts from the Arabian and Syrian deserts were blocked by high Omani mountains (˜3,000 m) during the late Southwest Monsoon so that desert dusts could not reach the southern Omani coast, where many volcanoes are active (e.g. 13 volcanoes in Yemen), Saudi Arabia (24 volcanoes), Iran (7 volcanoes), Iraq (1 volcano), India (4 volcanoes), and Pakistan (7 volcanoes). Oxygen minimum zones in the Arabian Sea (not in the open ocean where HNLC water present) forms due to the oxidation of volcanic sulfur compounds of S, SO₂, SO₃, and H₂SO₄ to sulfates (SO₄²⁻) (FIG. 3) by consuming the dissolved oxygen in waters. The previous study by NASA research team proposed the Omani coast of the Arabian Sea as HNLC during the late Southwest Monsoon (Naqvi et al., 2010). The Omani coast is located on the tectonic boundary of the Oman plate with S-replete extensive mud volcanoes at Borborok, Napag and Pirgel with seven active craters, while major deserts such as Arabian and Syrian are mobilizing their Fe-replete dust across 150 km long desert area to be mostly blocked by high Omani mountains (˜3,000 m) and Southwest Monsoon so that most of desert dusts except Iranian and Thar can not reach on the surface of the Omani coast. Nearby the southern Omani coast, there are many active and extinct volcanoes in the braket at Yemen (13), Saudi Arabia (24), Iran (7), Iraq (1), India (4) and Pakistan(7). Therefore, the contribution of sulfur from the volcanoes to the southern Omani coast can be far greater than that of iron from the deserts, which may be the reason why the southern Omani coast was regarded as HNLC by the NASA research team. Therefore, the contribution of volcanic S compounds to the southern Omani coast during the late Southwest Monsoon is much greater than those of Fe from deserts to satisfy the condition

$$\frac{dFe}{dt} < 0 , \frac{dS}{dt} ≫ 0 , and \vert \frac{dFe}{dt} \vert ≪ \vert \frac{dS}{dt} \vert$$

for HNLC region. 2) Fertilization potential near the Anatahan volcano in the Northern Mariana Islands of western North Pacific Subtropical Gyre showed low concentrations of nitrate (0.042 μM), phosphate (0.003 μM), and iron (0.002 μM) following the Anatahan eruption leading to the presence of the most oligotrophic LNLC ocean deserts on Earth [Lin et al., 2011] with chlorophyll-a of 0.07 μg·l⁻¹ [Tan et al., 2013]. In the western North Pacific Subtropical Gyre there are minimal Asian dust inputs and annually persistent Anatahan volcanic eruptions (2008, 2007, 2006, 2005, 2004, 2003) to satisfy the criteria of

$$\frac{dFe}{dt} < 0 , \frac{dS}{dt} > 0 , and \vert \frac{dFe}{dt} \vert < \vert \frac{dS}{dt} \vert$$

for LNLC region. 3) Benguela upwelling system in Southwestern Africa is one of the most productive fishery areas in the world with sand storms from Kalahari and Namib deserts in winter without any active volcanoes (Table 3). There are four more regions associated with major fisheries and coastal upwelling Currents -; i) Canary Current with Sahara desert but no volcanoes; ii) California Current with deserts of Mojave, Colo. and Great Basin but no active volcanoes; iii) Humboldt Current with desert of Atacama but no volcanic fallout due to Chilean volcanic ashes blown to the south and Argentina; and iv) Somali Current with desert of Danakil-Kaisut but no fallout of volcanic ashes since Southwest Monsoon during summer moves three active volcanic ashes from northeastward along with the coastal waters. These five coastal upwelling regions meet the criteria of

$$\frac{dFe}{dt} ≫ 0 , \frac{dS}{dt} < 0 , and \vert \frac{dFe}{dt} \vert ≫ \vert \frac{dS}{dt} \vert$$

for HNHC regions. 4) Indonesia has 127 active volcanoes but no desert. However, western Australian dusts from Great Victoria, Great Sandy, Gibson, Tanami, and Little Sandy deliver Fe-enriched dusts to Indonesian marine waters. Java Sea is surrounded by active volcanoes while the South Java Current flows eastward along the coast during the Northwest Monsoons. Nitrate (0.5˜1.5 μM), phosphate (0.05˜0.4 μM), silicate (4˜14 μM), and chlorophyll-a (0.3˜1.0 μg·l⁻¹) were monitored in Java Sea [Sachoemar and Yanagi, 2001], where is a major fishing ground in Indonesia. Java Sea of Indonesia meets the criteria:

$$\frac{dFe}{dt} ≫ 0 , \frac{dS}{dt} > 0 , and \vert \frac{dFe}{dt} \vert > \vert \frac{dS}{dt} \vert$$

for LNHC region.

Therefore, the present scheme of categorizing oceans in HNLC, LNLC, HNHC and LNHC regions by using the relative magnitude of the accumulation rates of Fe from deserts and subsurface water upwelling while S from volcanic sulfur compound in FIG. 3 appears to be reasonable.

As reviewed by Shaked and Lis (2012), small phytoplankton are favored under Fe limitation. On the basis of relative scale of Fe availability established from phytoplankton uptake rates, picoplankton such as Synechococcus and Synechocystis appear to be grazed by diatoms such as Thalassiosira spp. and Chaetoceros spp., flagellates of Phaecysts spp. and dinoflagellates of Chrysochromulina Ericina. Such results are in good agreement with other results for four size classes (0.2˜2, 2˜5, 5˜20, and >20 μm) of Fe cycle with the highest Fe uptake rate of picoplankton. It was suggested that copepod numbers can be controlled by a combination of competition and predation by krill, the latter being fed by humpback whale. It can be thus postulated that the route of Fe availability starts from picoplankton, diatoms, copepods and krill to the final destination of humpback whale. Therefore, in order to make a successful algal blooms for feasible atmospheric CO₂ sequestration, the size of Fe source must be smaller than of picoplankton (<2 μm). Since Fe in the aeolian dust was in the size of 0.3˜1 μm and summer krill were mainly in the top 100 m layer (Sverdrup, 1953) where cyanobacterium picoplankton stay for efficient photosynthesis and N₂-fixation, it is important to deploy the Fe enriched eco-friendly composite on ocean surfaces in components of Fe-replete fine silt and Australian clay in Tasmania (7 to 18% Fe compared to 3.5˜6% of the aeolian dust), Water-buoyant floating enhancer such as activated carbon black (˜0.1 μm), fine wood chip from sawmill (<˜1,400 μm) and iron-reducing marine bacterium Shewanella algae to reduce ferric iron (Fe³⁺) to ferrous iron (Fe²⁺) for facilitated assimilation to picoplankton. Since the wood chip is far greater than other components and its density is less than that of water, the wood chip may play a role of floating moiety whose surface is covered with iron oxides (0.05˜0.1 μm) from clay particles and reinforced carbon black (˜0.1 μm) and Chewanella algae (˜1.5×10⁷ CFU, colony-forming unit) with 100% survival in cold seawater (2° C.) over a period of 1 to 2 months (Gram et al., 1999). It is important to design appropriately the Fe enriched eco-friendly composite to be stayed longer on the top water (<100 m) to be readily available to algae rather than to be sedimented downwards and reacted with sulfate enriched ions to be insoluble FeS, which leads to the retardation of algal growth due to lack of iron.

The extracellular carbohydrate polymers from five desert soil algae with different cohesion were studied (Flu et al., 2003) in the stabilization of fine sand grain in the sequence of the great kinematic viscosity of Desmococcus olivaceus (1.1474), Scytonema javanicum (1.0278), Nostoc sp. (1.0149), Phormidium tenue (0.967), and Microcoleus vaginates (0.9434), which all belong to cyanobacteria except Desmococcus olivaceus. Among them, Scytonema javanicum and Nostoc sp. are N₂-fixing marine cyanobacteria. To minimize the occurrence of FeS and FeS₂ in the ocean, the best strategy of Fe-replete eco-friendly composite is to be floated on the surface of ocean as long as possible until its finely pulverized Fe component is assimilated to algae for their growth. Therefore, such two N₂-fixing desert soil algae can be used not only as the Fe-replete eco-friendly binder but also as a buoyancy promoter due to their copious viscous mucilage. Besides, agar from agaphyte may spherically encapsulate such a Fe-replete composite for better floating to be efficiently grazed by phytoplankton in the seawater.

Special precaution may be followed in the preparation of Fe enriched composite, not to violate the United Nations Convention on Biological Diversity (CBD) and the London Convention on the dumping of wastes at sea, as happened near the islands of Haida Gwaii in 2012. For the future iron fertilization, the deployment of Fe replete composite can be not in the common mode of FeSO₄ bubbled with SF₆ tracer, but in the mode of eco-friendly composite over the surface water of the fast flow rate (˜4 km per hour) of the Antarctic Circumpolar Current (ACC) and locate a few fertilizing ships at the same time to be perpendicular to ACC streamline for wide even distribution on the surface water not in patch length scale but in large scale (>>10 km).

In the present study, 6 new candidates for the successful location of the future iron fertilization are proposed as; 1) Bransfield Strait in Drake Passage of the Southern Ocean, 2) Shag Rocks of South Georgia in Scotia Sea of the Southern Ocean, 3) Mariana Islands-Guam, 4) Hawaiian Islands, 5) North Pacific Subtropical Gyre, and 6) west Iceland, all of which the humpback whales currently feed and breed. The most preferable location can be Shag Rocks (42° W)(200×50 km) of South Georgia due to the following reasons; 1) located at outside of major tectonic plate and micro plate boundaries (Barker, 2001), 2) located where the high nutrient (22.2˜28.8 μM nitrate) and high chlorophyll (0.46˜0.93 μg·l⁻¹) were present (Koike, 1986) while Antarctic Circumpolar Current dominated by diatoms cross flows with the Weddell Sea Deep Water dominated by coccolithophorids and silicoflagellates, 3) located at the South of the Polar Front dominated by diatoms, 4) located not far (185 km) from South Georgia Island (170×40 km) which is the unique position inside the Antarctic Convergence yet outside the limit of the yearly sea ice to be home to tens of millions of breeding penguins, 300,000 elephant seals, 3 million fur seals, and 25 species of breeding birds, implying its good location for phytoplankton productivity, 5) located not far from the forgotten whale station of Grytviken in South Georgia, which has been open in 1904 but closed in 1966 due to lack of whales. Since there are still massive elephant seals, fur seals, and king penguins at Grytviken but no humpback whales around, the latter feeding krill, plankton, and small fish, Grytviken can be a good base camp for the iron fertilizing ships and their crew residence not for several weeks, as commonly done in the previous 14 mesoscale iron experiments, but for several months or even years to apparently observe the iron stimulated productivity by satellite for chlorophyll and DMS. On-line monitorings of the algal removal rates of nitrate, phosphate and silicate by corresponding sensors, the algal production rates of dissolved oxygen (DO) in ocean and oxygen in atmosphere by DO and O₂ sensors, the algal consumption rates of dissolved carbon dioxide (DCO₂) in ocean or the fugacity of CO₂ in atmosphere by CO₂ sensors and the production rate of chlorophyll by chlorophyll sensor system can be continuously proceeded at fertilizing ships to see the effect of the iron fertilization. The light-dependent reaction of photosynthesis requires inorganic phosphate to convert H₂O to O₂, which leads to the increase of dissolved oxygen (DO) and thus the uptake rate of the phosphate and iron are also increased during the daytime for ATP production. Therefore, the iron deployment will be made during the daytime. The rate determining step for nitrogen uptake at the Fe-replete condition is the step from the nitrate (NO³⁻) to the nitrite (NO₂⁻) with electron transfer of NADPH under nitrate reductase, while the one at the Fe-starved condition is the step from the nitrite (NO₂⁻) to the ammonium (NH₄⁺) with electron transfer of ferredoxin (Walsh and Steidinger, 2001). Since the nitrate reductase prefers the anaerobic condition, the nitrogen uptake is mainly occurred during the nighttime, which is in good agreement with the diel variation of Synechococcus spp. of maximal cell concentration at midnight (Tsai et al., 2012). It is thus expected that Synechococcus grows during the night. However, diatoms are capable of dividing at any point of the diel cycle (Yool and Tyrrell, 2003). Therefore, the monitorings of chlorophyll, nitrate phosphate, and silicate concentrations after deploying the Fe-replete complex can be made throughout the day and the night for the accurate estimation and prediction of algal blooms.

The symptom of such a successful iron fertilization experiment can be seen by the increased rates of chlorophyll, DMS, DO, O₂, pCO₂, fugacity of atmospheric CO₂, concentrations along with the decreased rates of nitrate, phosphate, silicate concentrations while dominant plankton moves in the sequence of picoplankton, diatoms, copepods and krill to observe the return of humpback whale, for example, to Grytviken. Besides, such an iron fertilization should be carried out not in common mesoscale patch but in large scale for commercial feasibility of sequestering atmospheric CO₂ to be attractive not only to scientific groups but also big international companies for realistic commercialization of atmospheric CO₂ sequestration in compliance with Kyoto Protocol, under which emissions from developing countries are allowed to grow in accordance with their development needs, and countries actual greenhouse gas emissions have to be monitored and precise records have to be kept of the trades carried out. Humpback whales over 10,000˜15,000 worldwide live at the surface of the ocean, both in the open ocean and shallow coastline water. When not migrating, they prefer shallow waters. They migrate from warm tropical waters where they breed and calve to Arctic waters where they feed hill, plankton and small fish. In order to be successful in iron fertilization, its precise location can be shallow coastline water with abundant hill and copepods, the latter feeding ciliates and heterotrophic flagellates eating phytoplankton. Since HNLC regions are rich in nitrate, phosphate and silicate but starved iron, the iron fertilization is expected to increase the phytoplankton productivity starting from picoplankton until copepods and hill are abundant, which may induce in the long run the possible biomarker of the humpback whale to return to the vicinity of the forgotten whale station of Grytviken in South Georgia to convince the success of the iron fertilization, which can be cross-checked by satellite images of nitrate, chlorophyll and DMS (dimethyl sulfide) along with on-line database established by chlorophyll sensor to see the time and the extent of the transition from the current status of HNLC region before iron fertilization to the new status of LNHC region after iron fertilization, the latter being observed at 8 major fishing hot spots.

The optimal location for the large-scale sequestration of atmospheric CO₂ can be achieved if the iron fertilization is carried out not only as close to deserts but also as far from volcanoes, earthquakes and boundaries of tectonic plates. Fe-replete compounds are designed to stay as long as possible within 100 m surface ocean with aid of complex consisting of natural aeolian dust and/or clay, volcanic ash, mucilaginous cyanobacteria. Such a Fe-replete complex is encapsulated by agar so that phytoplankton can digest easily and slowly prior to its sinking to the deep ocean where iron is changed to iron sulfide (FeS) and eventually pyrites (FeS₂).

Oceans are firstly categorized by 4 groups such as 2 LC (HNLC, LNLC) and 2 HC (HNHC, LNHC) regions on the basis of the relative degree of the accumulation rates for iron from deserts and for sulfur from volcanoes.

It is important to design Fe enriched eco-friendly composite to be stayed longer on the top water (<100 m) to be readily available to algae rather than to be sedimented downwards and reacted with sulfate enriched ions to be insoluble FeS and FeS₂ which leads to the retardation of algal growth due to lack of iron. The future iron fertilization, the deployment of Fe replete composite cannot be in the common mode of FeSO₄ bubbled with SF₆ tracer, but in the mode of eco-friendly composite over the surface water of the fast flow rate (˜4 km per hour) of the Antarctic Circumpolar Current (ACC) and locate a few fertilizing ships at the same time to be perpendicular to ACC streamline for wide even distribution on the surface water not in patch length scale but in large scale (>>10 km). The most preferable location can be Shag Rocks (42° W) (200×50 km) of South Georgia due to the following reasons; 1) located at outside of major tectonic plate and micro plate boundaries (Barker, 2001), 2) located where the high nutrient (22.2˜28.8 μM nitrate) and high chlorophyll (0.46˜0.93 μg·l⁻¹) were present (Koike, 1986) while Antarctic Circumpolar Current dominated by diatoms cross flows with the Weddell Sea Deep Water dominated by coccolithophorids and silicoflagellates, 3) located at the South of the Polar Front dominated by diatoms, 4) located not far (185 km) from South Georgia Island (170×40 km) which is the unique position inside the Antarctic Convergence yet outside the limit of the yearly sea ice to be home to tens of millions of breeding penguins, 300,000 elephant seals, 3 million fur seals, and 25 species of breeding birds, implying its good location for phytoplankton productivity, 5) located not far from the forgotten whale station of Grytviken in South Georgia, which has been open in 1904 but closed in 1966 due to lack of whales. Since there are still massive elephant seals, fur seals, and king penguins at Grytviken but no humpback whales around, the latter feeding krill, plankton, and small fish, Grytviken can be a good base camp for the iron fertilizing ships and their crew residence not for several weeks, as commonly done in the previous 14 mesoscale iron experiments, but for several months or even years to observe the iron stimulated productivity apparently by satellite for chlorophyll and DMS. On-line monitorings of the algal removal rates of nitrate, phosphate and silicate by corresponding sensors, the algal production rates of dissolved oxygen (DO) in ocean and oxygen in atmosphere by DO and O₂ sensors, the algal consumption rates of dissolved carbon dioxide (DCO₂) in ocean or the fugacity of CO₂ in atmosphere by CO₂ sensors and the production rate of chlorophyll by chlorophyll sensor system can be continuously proceeded at fertilizing ships to see the effect of the iron fertilization. The light-dependent reaction of photosynthesis requires inorganic phosphate to convert H₂O to O₂, which leads to the increase of dissolved oxygen (DO) and thus the uptake rate of the phosphate and iron are also increased during the daytime for ATP production. Therefore, the iron deployment will be made during the daytime. The rate determining step for nitrogen uptake at the Fe-replete condition is the step from the nitrate (NO₃⁻) to the nitrite (NO₂⁻) with electron transfer of NADPH under nitrate reductase, while the one at the Fe-starved condition is the step from the nitrite (NO₂⁻) to the ammonium (NH₄⁺) with electron transfer of ferredoxin (Walsh and Steidinger, 2001). Since the nitrate reductase prefers the anaerobic condition, the nitrogen uptake is mainly occurred during the nighttime, which is in good agreement with the diel variation of Synechococcus spp. of maximal cell concentration at midnight (Tsai et al., 2012). It is thus expected that Synechococcus grows during the night. However, diatoms are capable of dividing at any point of the diel cycle (Yool and Tyrrell, 2003). Therefore, the monitorings of chlorophyll, nitrate phosphate, and silicate concentrations after deploying the Fe-replete complex can be made throughout the day and the night for the accurate estimation and prediction of algal blooms.

The symptom of such a successful iron fertilization experiment can be seen by the increased rates of chlorophyll, DMS, DO, O₂, pCO₂, fugacity of atmospheric CO₂, concentrations along with the decreased rates of nitrate, phosphate, silicate concentrations while dominant plankton moves in the sequence of picoplankton, diatoms, copepods and krill to observe the return of humpback whale, for example, to Grytviken. Besides, such an iron fertilization should be carried out not in common mesoscale patch but in large scale for commercial feasibility of sequestering atmospheric CO₂ to be attractive not only to scientific groups but also big international companies for realistic commercialization of atmospheric CO₂ sequestration in compliance with Kyoto Protocol, under which emissions from developing countries are allowed to grow in accordance with their development needs, and countries actual greenhouse gas emissions have to be monitored and precise records have to be kept of the trades carried out. Humpback whales over 10,000˜15,000 worldwide live at the surface of the ocean, both in the open ocean and shallow coastline water. When not migrating, they prefer shallow waters. They migrate from warm tropical waters where they breed and calve to Arctic waters where they feed hill, plankton and small fish. In order to be successful in iron fertilization, its precise location can be shallow coastline water with abundant hill and copepods, the latter feeding ciliates and heterotrophic flagellates eating phytoplankton. Since HNLC regions are rich in nitrate, phosphate and silicate but starved iron, the iron fertilization is expected to increase the phytoplankton productivity starting from picoplankton until copepods and krill are abundant, which may induce in the long run the possible biomarker of the humpback whale to return to the vicinity of the forgotten whale station of Grytviken in South Georgia to convince the success of the iron fertilization, which can be cross-checked by satellite images of nitrate, chlorophyll and DMS (dimethyl sulfide) along with on-line database established by chlorophyll sensor to see the time and the extent of the transition from the current status of HNLC region before iron fertilization to the new status of LNHC region after iron fertilization, the latter being observed at 8 major fishing hot spots.

The optimal location for the large-scale sequestration of atmospheric CO₂ can be achieved if the iron fertilization is carried out not only as close to deserts but also as far from volcanoes, earthquakes and boundaries of tectonic plates. Fe-replete compounds are designed to stay as long as possible within 100 m surface ocean with aid of complex consisting of natural aeolian dust and/or clay, volcanic ash, mucilaginous cyanobacteria. Such a Fe-replete complex is encapsulated by agar so that phytoplankton can digest easily and slowly prior to its sinking to the deep ocean where iron is changed to iron sulfide (FeS) and eventually pyrites (FeS₂).

Oceans are firstly categorized by 4 groups such as 2 LC (HNLC, LNLC) and 2 HC (HNHC, LNHC) regions on the basis of the relative degree of the accumulation rates for iron from deserts and for sulfur from volcanoes.

It is suggested to deploy the large-scale iron fertilization in terms of the high linear flow velocity (˜4 km/h) at the Antarctic Circumpolar Current in order to have a high momentum flux for the well dispersion of the Fe-replete complex.

Humpback whale is proposed as a biomarker for the successful iron fertilization in large-scale since humpback whale feeds krill, which feed cockpods and diatoms. The fast sinking rate of diatom (0.96 m d⁻¹) is very attractive for sequestration of CO₂.

What is claimed is:

1. A method of selecting an appropriate location for the large-scale sequestration of atmospheric CO₂, the method comprising:
selecting a location far from sources of volcanoes, earthquakes and boundaries of tectonic plates for less availability of sulfur compounds.

2. The method of claim 1, further comprising:
deploying Fe-replete eco-friendly composite on ocean surface in the selected location such that Fe-replete complex stays in a long period time within 100 m surface ocean with aid of Fe-replete eco-friendly composite to avoid chemical conversion of iron to iron sulfide and enhance phytoplankton digestion of iron.

3. The method of claim 2, wherein the Fe-replete eco-friendly composite is obtained from natural desert dust, clay, volcanic ash, mucilaginous cyanobacteria and agar.

4. The method of claim 2, wherein iron input for algal blooms is not bulk scale additions of direct iron or iron sulfate chemicals, but deploying natural clays or soils with content of iron in a range of 3.5 to 18 wt % as observed in the Continent or west Australia along with volcanic ash desulfurized by rainfall and weathering for long time of maximal 74 years.

5. The method of claim 1, wherein the location is selected from HNLC, LNLC, HNHC and LNHC regions of oceanic regions on the basis of the relative magnitude of the accumulation rates of iron from deserts and subsurface water upwelling and sulfur from volcanoes.

6. The method of claim 1, wherein the deployment of Fe-replete composite is carried out by the streamline of the Antarctic Circumpolar Current in order to have a high momentum flux for efficient dispersion of Fe-replete composite on the ocean surface where diatom, copepods, krill and humpback whale stay together.

7. The method of claim 1, wherein the success of the large-scale iron fertilization is claimed by the return of the humpback whale if there were no humpback whale for long time before the iron fertilization.

8. The method of claim 1, further comprising:
on-line monitoring for successful iron fertilization by checking simultaneous concentration changes of increases in chlorophyll, O₂, dissolved oxygen (DO) and dimethyl sulfide (DMS) and decreases in nitrate, phosphate, silicate, CO₂ and dissolved carbon dioxide (DCO₂).

9. The method of claim 1, wherein the locations for the large-scale iron fertilization are claimed as
1) Shag Rocks of South Geogia in Scotia Sea of the Southern Ocean, and
2) Bransfield Strait in Drake Passage of the Southern Ocean.

10. The method of claim 1, wherein Grytviken of South Georgia in Scotia Sea is claimed as the base camp for the iron fertilization for crews to reside more than months and years.

11. The method of claim 8, wherein said on-line monitoring is carried out at one fertilizing ship for fertilizing the Fe-replete composite which is located at an upward streamline of Antarctic Circumpolar Current (ACC) and another monitoring ship for monitoring a response of iron fertilization by using satellite (Chlorophyll-a, nitrate, DiMethyl Sulfide) and serial sensors (Chlorophyll-a, phosphate, silicate, iron, O₂, Dissolved Oxygen, CO₂, Dissolved Carbon Dioxide) which is positioned at a downward streamline of the ACC.

12. The method of claim 5, wherein LNLC regions such as west Iceland, Mariana Island/Guam of the U.S. Territory, Hawaiian Islands and North Pacific Subtropical Gyre are configured to be temporarily turned not only to LNHC regions with great hot fisheries but also the preferable locations for the large-scale iron fertilization to reduce the atmospheric CO₂.

13. The method of claim 8, wherein in said on-line monitoring, the monitoring of chlorophyll, nitrate, phosphate, and silicate concentrations after deploying the Fe-replete complex is carried out throughout the day and the night for the accurate estimation and prediction of algal blooms.

14. The method of claim 4, wherein the iron has a size of less than 2 μm.

15. The method of claim 2, further comprising:
deploying on the ocean surface in the selected location a water-buoyant floating enhancer and fine wood chips having a size less than 1,400 μm and iron-reducing marine bacterium, Shewanella algae, to reduce ferric iron (Fe³⁺) to ferrous iron (Fe²⁺) for facilitated assimilation to picoplankton.

16. The method of claim 15, wherein Scytonema javanicum and Nostoc sp. are used as a Fe-replete eco-friendly binder and as a buoyancy promoter.

17. The method of claim 15, wherein agar from agaphyte spherically encapsulate the Fe-replete composite for better floating to be efficiently grazed by phytoplankton in the seawater.
